(19) United States
(12) Patent Application Publication
(10) Pub. No.: US 2003/0014906 A1
(43) Pub. Date: Jan. 23, 2003

(54) Method for biological control of termites

(76) Inventor: David J. Roe, Pleasant Hill, CA (US)

Correspondence Address: ADAMS LAW OFFICE, Sharon J. Adams, 1867 Ygnacio Valley Rd., # 230, Walnut Creek, CA, 94598, US

(21) Appl. No.: 09/904,002

(22) Filed: Jul. 11, 2001

(51) Int. Cl. A01M 1/20; A01M 5/00; A01M 7/00; A01M 17/00

(52) U.S. Cl. 43/132.1

(57) ABSTRACT

A method for controlling termites using a biological control agent and a termite monitor wherein the bait in the termite monitor is treated with the biological control agent, thereby infecting the termites when they eat the bait.

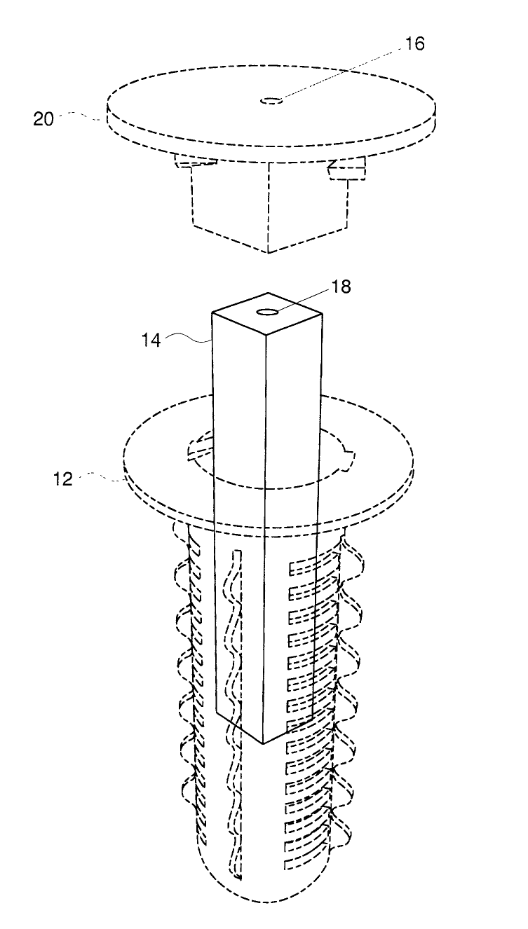

### CROSS REFERENCE TO RELATED APPLICATIONS

Not Applicable.

### FEDERAL SPONSORSHIP

Not Applicable.

### BACKGROUND

Termites can cause extensive damage to homes. Various systems have been described for detecting and controlling termites. For example, U.S. Pat. No. 5,329,726 issued to Thorne et al. on Jul. 19, 1994, and U.S. Pat. No. 5,555,672 issued to Thorne et al. on Sep. 17, 1996 describes a bait cartridge placed within a monitor implanted into the ground. The bait cartridge includes a highly preferred termite food. The bait cartridge is periodically removed and checked to determine if termites have been eating the bait cartridge. If the inspection discloses the presence of termites, the bait cartridge is replaced with a pesticide-containing bait cartridge. The termites eat the now-toxic bait cartridge, and will die. The disclosures of U.S. Pat. Nos. 5,329,726 and 5,555,672 are hereby expressly incorporated by reference herein.

There are other similar systems which generally use bait to detect the presence of termites, and then use bait laced with toxicant to kill the termites. For example U.S. Pat. No. 5,778,596 issued to Henderson et al. on Jul. 14, 1998 describes a bait system with two compartments, one compartment containing bait, and the other compartment containing bait laced with toxicant.

All of these devices, and other similar devices, require the use of toxic pesticides. When termites are detected by any of these methods, the bait material is replaced with material containing a pesticide. It is well know that pesticides can cause environmental problems. For example, termites live well below the ground, possibly even near the water table. Treated termites may carry water-soluble toxic pesticides into the colony and eventually into the water table. In addition, toxic pesticides may harm other beneficial insects and/or small children.

Moreover, use of toxic pesticides does not eliminate the termite colony. Termite colonies recognize that termites that have eaten now-toxic food source are dying. The remainder of the termites in the colony will no longer eat from that toxic food source. The termites will leave the area where the toxin is, but the termite colony will continue, and could re-infect the area at a later date.

Termites frequently eat in more than one area. They may be eating the bait station containing the toxicant, and at the same time they may be eating the structure of the house. As described above, the termites will cease eating the bait station once they realize it is toxic, but will often continue to eat the house structure. Because the bait station shows no signs of termites the homeowner may believe termites are eliminated, when in fact the termites are still eating the home.

Some patents describe the use of biological means for controlling termites and other insects. Biological means do not have the same negative an effect on the environment as pesticides. These patents use a fungus to control the insect. For example, U.S. Pat. No. 5,057,315 issued to Gunner et al. on Oct. 15, 1991 describes using entomopathogenic fungi to control cockroaches. Likewise, U.S. Pat. No. 5,057,316 issued to Gunner et al. on Oct. 15, 1991 describes using a fungus to control roaches, and flying insects. U.S. Pat. No. 5,189,831 issued to Miller et al. on Mar. 2, 1993 describes a method for controlling flying insects with an entomopathogenic fungus. All of these patents use the fungus in some sort of wet or moist medium. U.S. Pat. Nos. 5,057,315, and 5,057,316 describe depositing the fungus on a nutrient-containing agar. Using nutrient-containing agar to grow the fungus results in a poor storage life for the fungus. It is hard to store the fungus until needed. Moreover, the nutrient-containing medium is difficult to use, and tends to dry out quickly. Once the medium dries out the fungus will die and will no longer will effective at killing termites. The result is a short usable time period in which to kill termites.

U.S. Pat. No. 5,238,681 issued to Chang, et al. on Aug. 24, 1993 claims a device for dispensing entomopathgens (including fungi) to control various types of insects in an insect-consumable matrix. Again, in this patent, the matrix must be kept moist in order to be effective. Once placed in the field the matrix tends to dry out, especially under hot, summer conditions. All of the patents that describe using a moist medium to support the entomopathogens necessarily have a short effective life span.

All of the patents that describe using a entomopathogens in a moist medium are ineffective with termites. Termites do not like to be disturbed. If they are disturbed they will leave the immediate area, and may not return for weeks or months. However, the termite colony will continue. Using entomopathogens in a moist medium requires a two-step process. First, identify that termites are present. Second, if termites are found, place the monitor (containing the entomopathogens and medium) in the area. However, the termites will not crawl into a monitor immediately after it is placed because it is new, and considered a disturbance to the termites. By the time the termites are willing to crawl into the monitor, the medium will have dried out, and the entomopathogens will no longer be effective.

Additionally, as described in U.S. Pat. No. 5,057,316 (Gunner et al.), even if the medium remains moist the entomopathogenic fungi will likely produce a thick layer of mycelia and condia. This layer will, under certain conditions, produce a second mycelial layer may decrease the effectiveness of the conidial layer.

Some of the problems with the foregoing patents were addressed in U.S. Pat. No. 5,512,280, issued to Johal, et al. on Apr. 30, 1996. U.S. Pat. No. 5,512,280 describes a method for long term stabilization and storage of fungal conidia. U.S. Pat. No. 5,512,280 explains that fungal conidia infect the insect, eventually killing the insect. This patent does not require the use of a nutrient-based media and permits long-term storage of the fungal conidia. In addition, the fungal conidia used in U.S. Pat. No. 5,512,280 is a naturally occurring fungus. Thus, there is no toxicity problem associated with the use of this fungus. This patent teaches that the fungal conidial formation may be either administered to the insects, or sprayed in the area where there are termites are known to be present. The disclosure of U.S. Pat. No. 5,512,280 is expressly incorporated by reference herein.

For the foregoing reasons, there is a need for a biological agent for the control of termites that can be used without requiring a moist medium, and that can be used in a typical termite monitor.

### SUMMARY OF THE INVENTION

The invention solves the problems inherent in the prior art. The invention uses a typical termite monitor/bait station to administer a non-toxic fungal conidiospore. The invention describes a method for introducing the conidiospore into the termite colony without disturbing the termite colony.

A termite monitor containing bait is placed in an area where termites are suspected. The monitor is periodically inspected to determine if termites are present. If subsequent inspection of the bait shows the presence of termites, the fungal conidiospores are introduced to the monitor.

The fungal conidiospores have been stabilized for long-term storage. Once termite activity has been discovered, the fungal conidiospores are diluted to the proper concentration. The bait is treated with the diluted fungal conidiospores. The treated bait is returned to the monitor. The termites will eat the bait with the fungal conidiospores. The fungal conidiospores will become stuck to the termites, and the termites will carry the conidiospore back into the colony. The fungal conidiospores will be spread around the colony while the termites groom each other. Unlike ordinary pesticides, the termites do not recognize that the condiospore is infecting and killing them. The termites will continue to eat the bait that is treated with the conidiospore, thereby severely reducing or eliminating the termite colony.

### BRIEF DESCRIPTION OF THE DRAWING

These and other features, aspects, and advantages of the present invention will become better understood with regard to the following description, appended claims, and accompanying drawing, where:

The drawing shows an exploded view of a typical monitor with bait, as described in one embodiment of the invention.

### DESCRIPTION OF THE INVENTION

Termite monitors for monitoring the presence of termites are widely available. Termite monitors are sold under the names Term'atrol™, Exterra, First Line GT Plus, Terminix, Maxforce Outdoor Refillable Bait Station, and others. Any termite monitor that uses bait can be used with the invention.

Termite monitors typically have a housing 12 that contains bait 14 that is attractive to termites. A monitor containing bait 14 is placed in the ground. The monitor is typically made of plastic or other similar material. Bait may be any food that termites like to eat, typically wood, cardboard, paper, wallpaper, sheet rock paper, cellulose, or alpha cellulose.

The termite monitor is frequently inspected to determine if termites are present. The inventor currently prefers inspecting the monitors quarterly. The preferred method of inspection is to inspect the bait for termite activity without removing the bait. This is preferred because termites do not like to be disturbed. If their food source (the bait) is disturbed they will frequently refuse to return to that food source. Alternatively, inspection may be done by removing the bait and inspecting to determine if termites have been eating the bait. In addition, some termite monitors allow for inspection through the use of flags or other means that indicate that termites have been eating the bait. If there is no evidence of termite infestation the bait may be replaced in the monitor, or the monitor may be moved to a new location. If no termite activity is observed, the monitor and bait may be left in place indefinitely, and re-inspected at a later date.

If there is evidence of termite infestation there are several different methods for controlling termites according to the invention. The drawing shows one embodiment for delivering the biological control agent. This embodiment allows for repeated treatment with the biological control agent, described below. In this embodiment a small hole 16 is drilled in the top of the monitor 20, above the bait 14. A small hole 18 is also drilled through the bait 14, so that hole 18 in the bait 14 will line up with the hole 16 in the top of the monitor when the bait is in place. The inventor currently prefers using this method with wooden bait, but the method may be used with any bait that is thick enough to permit drilling a hole in the interior of the bait. The holes are drilled in the monitor and bait before the bait is placed in the monitor. The inventor currently prefers to drill a 1/8-inch hole in the bait and the monitor. However, the hole may be any size that allows the biological control agent to permeate the interior of the bait.

If, upon inspection, termite evidence is discovered the bait is treated with the biological control agent. Preferably, the biological control agent is applied to the bait by using a hypodermic syringe, without the needle, to deliver an aqueous solution of the biological control agent into hole 16. Alternatively, the bait is removed and dipped in a biological control agent. The hole in the bait permits the biological control agent to further permeate the bait. Tables 1 and 5, below, show the results obtained using this method. After treating the bait the following steps may be used with any of the methods described herein. The addition of approximately one to five tablespoons of aqueous biological control agent to the bait every five to ten days to add. The addition of approximately one-half to one cup of biological control agent (mixed according to the manufacturer's instructions) to the bottom of the monitor often increases effectiveness. The aqueous biological control agent will disperse into the surrounding termite tubes. Termites coming to the bait to feed will come through the tubes that now have been moistened with the aqueous biological control agent. The liquid in the bottom of the monitor or in the tubes does not disturb the termites, apparently because it seems like an ordinary natural occurrence, like rain, to them. The additional liquid will help ensure that the termites come into contact with the biological control agent. Pouring the biological control agent around the monitor may also increase effectiveness. Again, this does not disturb the termites, and increases the effectiveness of the biological control agent.

In another embodiment, once termite infestations has been observed, the bait is treated with the biological control agent by simply pouring an aqueous solution of the biological control agent on the bait. This method is one of the best methods because it results in the least disturbance to the termites.

In another embodiment, the existing bait (with evidence of termite infestation) is removed, dipped into the biological control agent, and replaced in the monitor. The bait is the same piece of wood, cardboard, or the like, that the termites have been feeding on. The termites do not notice that it has been dipped into the biological control agent. Tables 2 and 4, below, shows the results obtained using this method.

In another embodiment, the existing bait is removed. A new bait cartridge is inserted into the monitor. The new bait has been treated with the biological control agent, as described above. Table 3, below, shows the results obtained using this method.

Currently, the preferred biological control agent is sold under the trademark Bio-Blast ™ from Paragon Pest Control Products. In the preferred embodiment, the biological control agent is prepared and diluted according to the manufacturer's instructions, at a concentration of 0.5%. However, the Bio-Blast™ agent may be administered in concentrations greater or lesser than recommended by the manufacturer. Alternatively, the biological control agent is the fungal conidial formulation described in U.S. Pat. No. 5,512,280. Any and all of the formulations described in U.S. Pat. No. 5,512,280, both wet and dry, may be used with the invention. Further, the conidial formulation may be administered in any concentration described in U.S. Patent No. 5,512,280.

Bio-Blast™, or the fungal conidial formulation described in U.S. Pat. No. 5,512,280, contains living organisms, the fungal conidiospores. When a termite comes in contact with Bio-Blast™, or the fungal conidial formulation described in U.S. Pat. No. 5,512,280, the fungal spores attach to the termite body. The termite will carry the spores into the termite nest, and through grooming, infect many other termites. The spores invade the termites' bodies and eventually cause death.

Unlike toxic pesticides, the termites do not recognize that the bait they are eating has been treated. The termites will continue to eat the bait cartridge, and will carry the condiospores deep into the termite colony. The termites will transfer the condiospores from one to another through their normal grooming process. Thus, the entire colony, or almost the entire colony, will have spores on their bodies. The condiospores will germinate and begin infecting the colony.

Tables 1, 2, 3, 4 and 5 show the results obtained in using the methods described above.

TABLE 1
Experiment #1

| | | |
|---|---|---|
| Day 1 | Treated according | Termites present |
| | to invention | |
| Day 32 | | Slight infestation |
| Day 36 | | No infestation |
| Day 40 | | No infestation |
| Day 66 | | No infestation |
| Day 108 | | No infestation |

TABLE 2
Experiment #2

| | | |
|---|---|---|
| Day 1 | Treated according | Termites present |
| | to invention | |
| Day 4 | | Termites present |
| Day 18 | | Termites present |
| Day 36 | | No infestation |
| Day 85 | Monitor fungus | No infestation |
| | damaged. New | |
| | monitor installed | |
| | and treated. | |
| Day 132 | | No infestation |
| Day 170 | | No infestation |
| Day 234 | | No infestation |

TABLE 3
Experiment #3

| | | |
|---|---|---|
| Day 1 | Treated according | Termites present |
| | to invention | |
| Day 8 | | Termites present |
| Day 20 | | Termites present |
| Day 44 | | No infestation |
| Day 48 | | No infestation |
| Day 60 | | No infestation |
| Day 93 | | No infestation |
| Day 159 | | No infestation |

TABLE 4
Experiment #4

| | | |
|---|---|---|
| Day 1 | Treated according | Termites present |
| | to invention | |
| Day 3 | | Termites present |
| Day 8 | | Termites present |
| Day 27 | | Termites present |
| Day 42 | | No infestation |
| Day 57 | | No infestation |
| Day 123 | | No infestation |
| Day 181 | | No infestation |

TABLE 5
Experiment #5

| | | |
|---|---|---|
| Day 1 | Treated according | Termites present |
| | to invention | |
| Day 9 | | Termites present |
| Day 20 | | No infestation |
| Day 38 | | No infestation |
| Day 44 | | No infestation |

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

What is claimed is:

1. A method for increasing the mortality of termites comprising:
(a) placing bait in a monitor in the ground to detect the presence of termites;
(b) inspecting the monitor and bait to determine if termites are present;
(c) if termites are detected, treating the existing bait with a fungal conidial formulation.

2. The method of claim 1 wherein the bait is selected from the group consisting of wood, cardboard, paper, wallpaper, sheet rock paper, cellulose, or alpha cellulose.

3. The method of claim 1 wherein an aqueous solution of the fungal conidial formulation is delivered to the bait without disturbing the bait.

4. The method of claim 3 wherein a hole is drilled into the top of the monitor and another hole is drilled into the bait so that hole in the top of the monitor and the hole in the bait line up, and an aqueous solution of the fungal conidial formulation is periodically added to the hole.

5. The method of claim 1 wherein the bait is treated with a dry fungal conidial formulation.

6. The method of claim 1 wherein a sufficient amount of aqueous solution of the fungal conidial formulation is added to the bottom of the monitor sufficient to saturate the bottom of the monitor and disperse into the termite tubes coming into the monitor.

7. The method of claim 1 wherein a sufficient amount of aqueous solution of the fungal conidial formulation is poured around the circumference of the monitor to saturate the surrounding soil.

8. The method of claim 1 wherein the bait is dipped in an aqueous solution of the fungal conidial formulation.

9. A method for increasing the mortality of termites comprising:
(a) placing bait in a monitor in the ground to detect the presence of termites;
(b) inspecting the monitor and bait to determine if termites are present;
(c) if termites are detected, treating the existing bait with a biological control agent sold under the trademark Bio-Blast™.

10. The method of claim 9 wherein the bait is selected from the group consisting of wood, cardboard, paper, wallpaper, sheet rock paper, cellulose, or alpha cellulose.

11. The method of claim 9 wherein an aqueous solution of Bio-Blast™ is delivered to the bait without disturbing the bait.

12. The method of claim 9 wherein the bait treated with dry Bio-Blastυ.

13. The method of claim 11 wherein a hole is drilled into the top of the monitor and another hole is drilled into the bait so that hole in the top of the monitor and the hole in the bait line up, and an aqueous solution of Bio-Blast™ is periodically added to the hole.

14. The method of claim 9 wherein a sufficient amount of an aqueous solution of Bio-Blast™ is added to the bottom of the monitor sufficient to saturate the bottom of the monitor and disperse into the termite tubes coming into the monitor.

15. The method of claim 9 wherein a sufficient amount of an aqueous solution of Bio-Blast™ is poured around the circumference of the monitor to saturate the surrounding soil.

16. The method of claim 9 wherein the bait is dipped in an aqueous solution of Bio-Blast™.
